(19) United States
(12) Patent Application Publication
(10) Pub. No.: US 2026/0084415 A1
(43) Pub. Date: Mar. 26, 2026

(54) PRINTING APPARATUS, CONTROL METHOD, AND STORAGE MEDIUM

(71) Applicant: CANON KABUSHIKI KAISHA, Tokyo (JP)

(72) Inventors: SHOTA SAKANO, Kanagawa (JP); KAZUKI HIROBE, Tokyo (JP)

(21) Appl. No.: 19/333,602

(22) Filed: Sep. 19, 2025

(30) Foreign Application Priority Data
Sep. 26, 2024 (JP) 2024-167258

(51) Int. Cl. B41J 2/045

(52) U.S. Cl. CPC B41J 2/04543; B41J 2/04568; B41J 2/04573; B41J 2/0458; B41J 2/04588; B41J 2/04593; B41J 2202/12

(57) ABSTRACT

A printing apparatus includes: a printing head including first heating resistance elements which generate an energy for ejecting a liquid from ejection ports, and second heating resistance elements which generate an energy for generating a flow of the liquid in a flow passage; and a control unit which controls the printing head based on ejection data indicating ejection/non-ejection for each ejection port, and drive data indicating whether driving is enabled for the second heating resistance elements, the control unit including a heat-level calculation unit deriving a heat level based on the ejection data and the drive data, and a drive pulse generation unit generating a drive pulse in accordance with the derived heat level, wherein the heat-level calculation unit includes a calculation unit which calculates the number of the second heating resistance elements to be simultaneously driven, based on the ejection data and the drive data.

### BACKGROUND

### Field of the Technology

The present disclosure relates to a printing apparatus, a control method, and a storage medium.

### Description of the Related Art

As a liquid ejection head, there is an inkjet printing head which ejects an ink, for example. In an inkjet printing head, there is a possibility that a volatile component in an ink is evaporated from ejection ports from which to eject the ink, and the ink in the ejection ports is thickened. There is a case where due to such thickening of an ink, an ejection speed of the ink and the like change to cause ejection failures including a decrease in landing accuracy of the ink. Particularly, in the case where a halt time of an ejection operation of an ink is long, the ink viscosity significantly increases, a solid component in the ink sticks in the ejection ports, and the flow resistance of the ink increases, so that ejection failures of the ink easily occur.

As a measure against such a thickening phenomenon of a liquid, a method which causes a fresh liquid to flow through ejection ports in a liquid chamber has been known. There is a system of circulating a liquid in a head with a pressure difference by using a main body-side pump included separately from a fluidic die for ejection as means of the method. In addition, there is also a system including a circulation element in a fluidic die itself for circulation as other means.

Japanese Patent Laid-Open No. 2020-104312 discloses a configuration including a flow energy generation element in a fluidic die to circulate a liquid through an ejection port array between both end portions relative to a flow passage extending to intersect the ejection port array as an example of a circulation element which a fluidic die itself includes.

By the way, in a printing head, an ink is ejected from ejection ports by determining a drive pulse to be applied to first heating resistance elements (ejection heaters) which are simultaneously driven. In this case, as the amount of the ink to be simultaneously ejected increases, a necessary electric power also increases. For this reason, there is a problem that in the case where the drive pulse to be applied is not appropriate, such inappropriate drive pulse leads to ejection failures and a decrease in image quality.

As a method for solving this problem, Japanese Patent Laid-Open No. 2004-58527 discloses a method in which the number of first heating resistance elements with a plurality of sizes which are simultaneously driven is counted, and a drive pulse is controlled based on the result of the count. In this method, for ink droplets of a plurality of sizes, the number of the first heating resistance elements to be simultaneously driven for each size is counted, and a drive pulse to be applied to the first heating resistance elements to be simultaneously driven is determined based on the result of the count, for the first heating resistance elements for each size. This can prevent the above-described ejection failures.

### SUMMARY

However, at a timing at which second heating resistance elements (circulation modules) are made valid separately from the first heating resistance elements, the circulation of the ink is also conducted in addition to the ejection of the ink. For this reason, it is necessary to supply a drive pulse obtained by additionally considering the drive of the second heating resistance elements. However, the aforementioned Patent Literature does not consider the second heating resistance elements to be simultaneously driven. In this case, since the drive of the second heating resistance elements is not taken into account, there is a possibility that ejection failures of the ink and a decrease in image quality are caused by an inappropriate drive pulse applied.

Therefore, in view of the above-described problem, an object of the present disclosure is to provide a technology for applying an appropriate drive pulse.

An embodiment of the present invention is a printing apparatus comprising: a printing head which includes a plurality of first heating resistance elements which generate an energy for ejecting a liquid from a plurality of ejection ports, and a plurality of second heating resistance elements which generate an energy for generating a flow of the liquid in a flow passage; and a control unit which controls the printing head based on ejection data indicating ejection or non-ejection for each of the plurality of ejection ports, and drive data indicating whether or not driving is enabled for the plurality of second heating resistance elements, the control unit including a heat-level calculation unit which derives a heat level based on the ejection data and the drive data, and a drive pulse generation unit which generates a drive pulse in accordance with the derived heat level, in which in a case where the ejection data for each of the plurality of ejection ports indicates non-ejection and the drive data indicates that driving is possible, the control unit drives the second heating resistance element corresponding to the each ejection port, wherein the heat-level calculation unit includes a calculation unit which calculates the number of the second heating resistance elements to be simultaneously driven, based on the ejection data and the drive data.

Features of the present disclosure will become apparent from the following description of embodiments with reference to the attached drawings. The following description of embodiments is described by way of example.

### BRIEF DESCRIPTION OF THE DRAWINGS

FIG. 1A and FIG. 1B are perspective views showing a schematic configuration of a liquid ejection apparatus including a liquid ejection head.

FIG. 2A to FIG. 2D are diagrams showing configurations of the liquid ejection head.

FIG. 3A to FIG. 3D are schematic views of vicinities of ejection ports of the liquid ejection head.

FIG. 4 is a diagram showing a circuit configuration.

FIG. 5 is a diagram showing a circuit configuration of a printing element board.

FIG. 6A and FIG. 6B are diagrams showing a control data supply circuit.

FIG. 7 is a block diagram showing a control configuration of a printing apparatus.

FIG. 8 is a block diagram showing a configuration of a printing head control unit.

FIG. 9 is a diagram showing generation of a data transfer timing.

FIG. 10 is an image diagram of a data signal and the like.

FIG. 11 is a block diagram showing a configuration of a heat-level calculation unit.

FIG. 12 is a diagram showing count of the number of second heating resistance elements.

FIG. 13 is a flowchart of processing of determining a drive pulse, and generating and transmitting the determined drive pulse.

### DESCRIPTION OF THE EMBODIMENTS

Hereinafter, preferred embodiments of the present disclosure will be described in detail with reference to the attached drawings. Note that the following embodiments are not intended to limit Claims more than necessary, and all the features described in the following embodiments are not necessarily essential for the solution of the present disclosure. Note that the same constituent elements are denoted by the same reference signs. Hereinafter, first, the basic configurations of the present disclosure will be described, and subsequently, the characteristic configurations of the present disclosure will be described.

### First Embodiment

### Liquid Ejection Apparatus

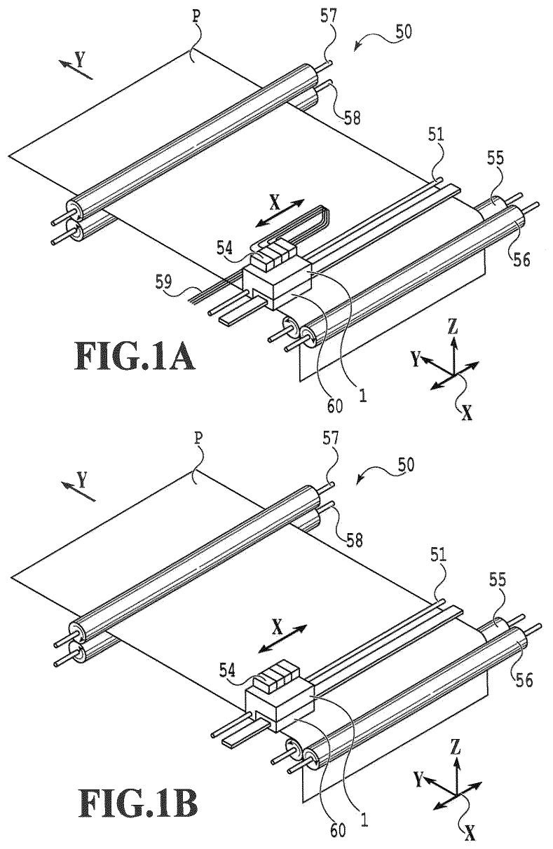

Hereinafter, the schematic configuration of a liquid ejection apparatus 50 in the present embodiment will be described. FIG. 1A and FIG. 1B are enlarged views of a liquid ejection head 1 of the liquid ejection apparatus 50 and its surroundings, and are perspective views schematically showing the liquid ejection apparatus using the liquid ejection head. The liquid ejection apparatus 50 is a liquid ejection apparatus of a form which prints an image by ejecting a liquid onto a printing medium P by using a liquid ejection head which scans in a direction intersecting a conveyance direction of the printing medium P (serial-type liquid ejection apparatus). Note that although the present disclosure will be described here by giving a serial-type liquid ejection apparatus as an example, the application target of the present disclosure is not limited to only a serial-type liquid ejection apparatus. The present disclosure can also be applied to a page wide-type liquid ejection apparatus which prints an image by ejecting a liquid onto a printing medium which is conveyed in a conveyance direction by using a line head which is long in a page-width direction of the printing medium (page wide-type head). Note that an example of the liquid ejection head 1 includes a printing head which conducts printing by ejecting ink droplets.

The liquid ejection head in the present embodiment is capable of ejecting inks of 4 types, that is, black (K), cyan (C), magenta (M), and yellow (Y), and is capable of printing a full-color image by using these inks. Note that the inks which can be ejected from the liquid ejection head are not limited to the above-described inks of 4 types. The present disclosure can also be applied to a liquid ejection head for ejecting inks of other types. That is, the types and numbers of inks to be ejected from the liquid ejection head are not limited.

In the serial-type liquid ejection apparatus 50, the liquid ejection head 1 is mounted on a carriage 60. The carriage 60 reciprocates in a main scanning direction (X-direction) along a guide shaft 51. The printing medium is conveyed in a sub scanning direction (Y-direction) which intersects the main scanning direction (orthogonal thereto in the present example) by conveyance rollers (conveyance units) 55, 56, 57, and 58. Note that in each drawing which is referred to below, the Z-direction indicates a vertical direction, and intersects an X-Y plane defined by the X-direction and the Y direction (orthogonal thereto in the present example).

FIG. 1A shows a configuration in which a main ink tank as a liquid reservoir unit is provided outside the liquid ejection head. The liquid (ink) stored in the ink tank is supplied to a sub ink tank 54 on the liquid ejection head 1 side via an ink supply tube (liquid communication passage) 59 and the like by a drive force of an external pump. On the other hand, FIG. 1B shows a configuration in which an ink tank 54 is included directly above the liquid ejection head 1 (which does not include a main ink tank as a liquid reservoir unit outside the liquid ejection head). In this case, there is also a case where the liquid ejection head 1 is provided integrally with the ink tank 54 and configured to be detachable from/attachable to the carriage 60. Alternatively, there is also a case where the liquid ejection head 1 is provided integrally with the carriage 60, and only the ink tank 54 is configured to be detachable from/attachable. The following description will be made by using the configuration of FIG. 1A as a representative example.

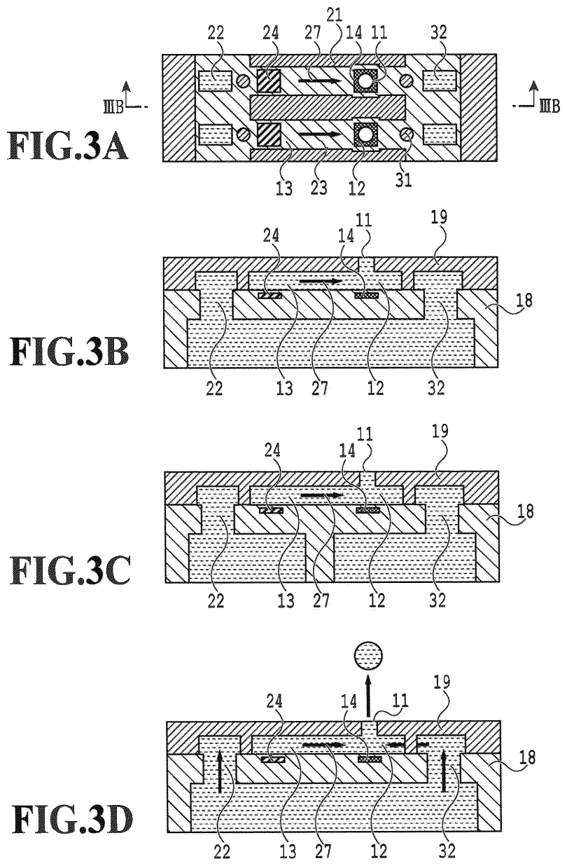

The liquid ejection head 1 is configured to include individual ejection units, which will be described later (see FIG. 3A to FIG. 3D). Although the specific configuration will be described later, each individual ejection unit is provided with ejection ports for ejecting the liquid, and pressure chambers which communicate with the ejection ports. Moreover, each individual ejection unit is provided with first energy generation elements which are provided in the pressure chambers, individual flow passages which communicate with the pressure chambers, and second energy generation elements which are provided in the individual flow passages. Here, the first energy generation element are ejection energy generation elements which generate an energy for ejecting the liquid from the ejection ports, and the second energy generation elements are flow energy generation elements. The liquid ejection head 1 includes a plurality of the individual ejection units, and includes supply flow passages for supplying the liquid to the individual flow passages in the respective individual ejection units.

In the case of using a liquid ejection head, there is a case where the ejection of a liquid is destabilized by the evaporation of a volatile component such as a water content from ejection ports, the condensation of a solid component near the ejection ports associated with this, and the like, and various measures have been made in order to prevent this. For example, the liquid ejection apparatus may be provided with a cap member (not shown) which is capable of covering the ejection port face in which the ejection ports of the liquid ejection head are formed, at a position displaced from the conveyance path of the printing medium in the X-direction. The cap member is used for the purpose of preventing the ejection ports from drying or protecting the ejection ports by covering the ejection port face of the liquid ejection head in a case where the printing operation is not conducted, and the like cases. Moreover, an ink suction mechanism (not shown) may also be provided, and in this case, the cap member is used for an ink suction operation from the ejection ports, and the like. By conducting this ink suction operation, the ink near the ejection ports is refreshed, so that the image quality to be obtained can be maintained. In addition, methods for discarding the condensed ink by conducting preliminary ejection when a printing operation is not conducted, or for preliminarily ejecting a predetermined amount of the ink (sheet-surface preliminary ejection/intra-page preliminary ejection) at a position which is less visible in terms of the image quality on the printing medium during the printing operation as well, and the like. In the case of employing these methods, although the methods greatly contribute to an improvement in image quality, part of the ink is discarded to refresh the ejection ports. Hence it is desirable to reduce the waste ink amount as much as possible.

Against such problems, it is possible to suppress the drying in the ejection ports and the condensation of the ink near the ejection ports while reducing the waste ink amount, by providing the second energy generation elements (flow energy generation elements) in the individual flow passages and circulating the ink in the flow passages. Specifically, the number of times of the preliminary ejection or the suction recovery can be reduced as many as possible. If the number of times of the preliminary ejection or the like can be reduced as many as possible, it also leads to an improvement in throughput or yield.

It is unnecessary to provide the second energy generation element (flow energy generation element) in all the individual ejection units of the liquid ejection head. As long as the second energy generation element (flow energy generation element) is provided in some of the individual ejection units, it is possible to obtain the above mentioned effect as compared with the case where the second energy generation element (flow energy generation element) is not provided.

In addition, the liquid ejection head shown in FIG. 1A may have a configuration in which all the portions corresponding to the inks of 4 types include the second energy generation elements, or may have a configuration in which only the portion corresponding to an ink of 1 type includes the second energy generation element. That is, the liquid ejection head may have a configuration in which all the inks of 4 types are not circulated, but only an ink of at least 1 type is circulated.

### Basic Configuration of Liquid Ejection Head

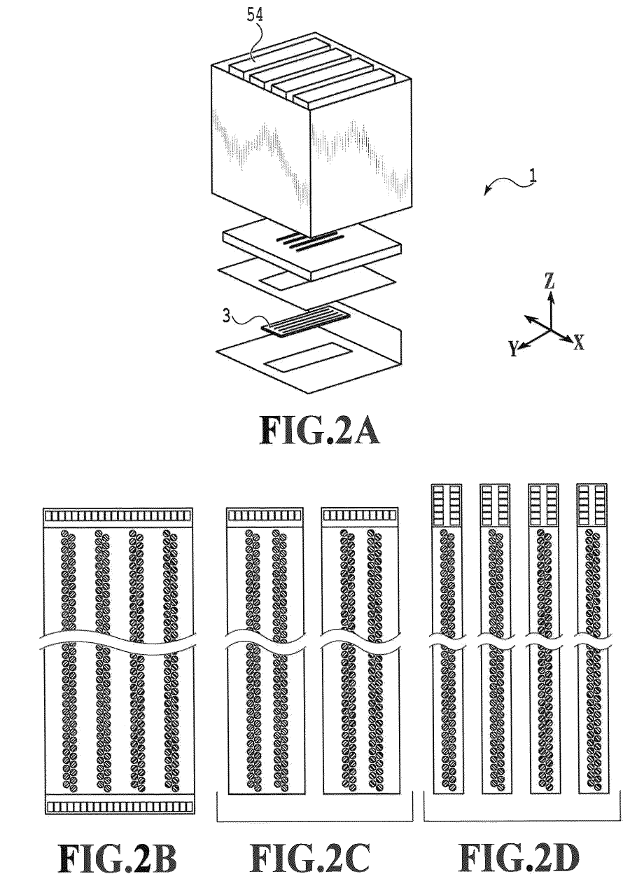

FIG. 2A is an exploded perspective view of the liquid ejection head in the present embodiment. As shown in FIG. 2A, the liquid ejection head is configured to include the sub ink tanks 54 which temporarily store the inks in the head, and a liquid ejection chip 3 for ejecting the inks supplied from the sub ink tanks 54 onto the printing medium P. The liquid ejection head in the present embodiment is fixed and supported on the carriage by a positioning unit and an electrical contact, which are provided in the carriage of the liquid ejection apparatus and which are not shown. The liquid ejection head conducts printing on the printing medium P by ejecting the inks while moving together with the carriage in the main scanning direction (X-direction) shown in FIG. 1A and FIG. 1B.

The external pumps, which are connected to the ink tanks serving as the ink supply sources, are provided with ink supply tubes 59 (see FIG. 1A). Liquid connectors, which are not shown, are provided in the front ends of the ink supply tubes. In the case where the liquid ejection head 1 is mounted in the liquid ejection apparatus 50, the liquid connector provided in the front end of the ink supply tube 59 is liquid tightly connected to a liquid connector insertion slot serving as an inlet port of the liquid, which is provided in a head housing of the liquid ejection head 1. In this way, an ink supply passage extending from the ink tank to the liquid ejection head 1 through the external pump is formed. In the present embodiment, since inks of 4 types are used, four sets of the ink tanks, the external pumps, the ink supply tubes 59, and the sub ink tanks 54 are provided corresponding to the respective inks, and four ink supply passages corresponding to the respective inks are independently formed. In this way, the liquid ejection apparatus in the present embodiment includes an ink supply system in which the inks are supplied from the ink tanks provided outside the liquid ejection head 1. Note that the liquid ejection apparatus in the present embodiment does not include an ink recovery system to recover the inks in the liquid ejection head to the ink tanks. Hence, in the liquid ejection head, the liquid connector insertion slots for connecting the ink supply tubes of the ink tanks are provided, but connector insertion slots for connecting tubes for recovering the inks in the liquid ejection head to the ink tanks are not provided. Note that the liquid connector insertion slots are provided for the respective inks.

FIG. 2B, FIG. 2C, and FIG. 2D are overall views of liquid ejection chips included in the liquid ejection head. FIG. 2B shows a configuration of one chip for four colors. FIG. 2C shows a configuration of one chip for two colors. FIG. 2D shows a configuration of one chip for one color. In each of the liquid ejection chips, ejection ports and pads used for electrical installation are provided. Note that FIG. 2A shows a liquid ejection head including the chip configuration of FIG. 2B.

FIG. 2B shows a first example in which one chip is configured for four colors. The four colors are, for example, black, cyan, magenta, and yellow. Arrays are configured with the respective colors, and are arrayed in the Y-direction. Ejection ports of each array are adjacent to each other and displaced in the X-direction, and disposed at equal intervals along the Y-direction. Here, the ejection ports of the arrays may be arrayed side by side in one array along the Y-direction without being displaced in the X direction. In addition, only black may be arranged in two arrays such that five arrays in total may be arranged for four colors.

FIG. 2C shows a second example in which one chip is configured for two colors and two chips are used. In the case of mounting two chips on a liquid ejection head, two chips may be mounted on one liquid ejection head, or two liquid ejection heads on each of which one chip is mounted may be prepared.

FIG. 2D is a third example in which one chip is configured for one color and four chips are used. In the case of mounting four chips on a liquid ejection head, four chips may be mounted on one liquid ejection head, or four liquid ejection heads on each of which one chip is mounted may be prepared.

In the case where a plurality of chips are divided as shown in FIG. 2C and FIG. 2D, all the chips do not have to have the same chip length. In addition, various other combinations of colors on chips are possible, and the same applies to a case where the total number of colors is more than four.

### Configuration of Circulation Unit

FIG. 3A to FIG. 3D are schematic views for explaining vicinities of ejection ports of a straight-type liquid ejection head. The term “straight-type” means a shape in which an individual flow passage in which a first energy generation element (ejection energy generation element) and a second energy generation element (flow energy generation element) are disposed is disposed such that two end portions of the individual flow passage are located on two sides sandwiching an ejection port array. Specifically, the term “straight-type” means that the aforementioned individual flow passage has a straight shape extending in a direction intersecting an ejection port array (a direction orthogonal thereto in the cases of FIG. 3A to FIG. 3D). In other words, in the individual flow passage of the individual ejection unit, the first energy generation element and the second energy generation element are disposed in a direction intersecting the ejection port array.

FIG. 3A is a plan view as viewed in a direction in which liquid droplets are ejected from ejection ports. FIG. 3B is a sectional view taken along section line IIIb-IIIb′ of FIG. 3A, and FIG. 3C is a sectional view different from FIG. 3B. FIG. 3D is a view for explaining an inflow of the ink in the case where the first energy generation element is driven.

In FIGS. 3A to 3C, between a substrate 18 and an orifice plate 19, pressure chambers 12 corresponding respectively to ejection ports 11, and individual flow passages 23 for allowing the ink to flow through the pressure chambers 12 are formed while being separated by partition walls 21. In the ejection ports 11, a meniscus of the ink is formed, and an ejection port interface as an interface between the ink and the atmospheric air is formed.

The substrate 18 is provided with first energy generation elements 14 which generate an energy for ejecting the ink in the pressure chambers. In the present example, as the first energy generation elements 14, thermoelectric conversion elements are used. The first energy generation elements 14 are located together with the ejection ports 11 and the pressure chambers 12 at positions closer to second supply openings 32 than to first supply openings 22. By driving the first energy generation elements 14 to generate heat and generate bubbles in the ink in the pressure chambers 12, the ink can be ejected from the ejection ports 11 by utilizing the bubble-generating energy. The first energy generation elements are not limited to thermoelectric conversion elements as in the present example, but piezoelectric elements or the like may be used.

In addition, the substrate 18 is provided with second energy generation elements 24 which generate an energy for generating circulation flows 27 indicated by arrows in the ink in the individual flow passages. In the present example, as the second energy generation elements 24, thermoelectric conversion elements are used. In the present example, the second energy generation elements 24 are provided in one-to-one correspondence with the plurality of first energy generation elements 14, respectively.

Moreover, the substrate 18 is provide with an opening for supplying the liquid from a common flow passage to the individual flow passages. This opening may have a configuration having a plurality of openings (independent supply openings) as shown in FIG. 3A, or may be a supply groove as a single large opening. The second energy generation elements 24 are located closer to the first supply openings 22 than to the second supply openings 32.

The individual flow passages 23 extend in a second direction intersecting a direction (first direction) in which the ejection ports are arrayed to form arrays (orthogonal thereto in the case of the present example). The individual flow passages 23 include the pressure chambers 12, inlet (upstream)-side connection flow passages 13 in FIG. 3B, which communicate with one end portions of the pressure chambers 12, and outlet (downstream)-side flow passage in FIG. 3B, which communicate with the other end portions of the pressure chambers 12. The individual flow passages 23 communicate with first supply openings 22 which penetrate the substrate 18 at one end on the upstream side, and communicate with second supply openings 32 which penetrate the substrate 18 at the other end on the downstream side. Hence, the inlet (upstream)-side connection flow passages 13 are located closer to the second energy generation elements 24 than to the ejection port arrays. Both end portions of the individual flow passage 23 are located on the opposite sides of the ejection port array.

The ink flow flowing through the individual flow passages is broadly classified into (1) a first ink flow in the case of driving the first energy generation elements 14 and conducting refill after the ejection, and (2) a second ink flow in the case of driving the second energy generation elements 24 to form a circulation flow.

In the case of driving the first energy generation elements 14 to eject the liquid from the ejection ports 11, the ink associated with the ejection is supplied from the first supply openings 22 and the second supply openings 32 as shown in FIG. 3D, and thus the ink flows into the pressure chambers from both supply openings.

In the case of driving the second energy generation elements 24 to form a circulation flow, the ink flows into the individual flow passages 23 through the first supply openings 22 which are on the connection flow passage side, and flows out to the outside through the second supply openings 32 which are not on the connection flow passage side. In the present example, the ink which has flowed out from the second supply openings 32 is returned to the first supply openings 22 and is circulated to form a circulation flow 27 indicated by the arrows in the individual flow passages 23. Note that a configuration in which the first supply openings 22 and the second supply openings 32 are made common in a chip is the configuration shown in FIG. 3B. In addition, a configuration in which the first supply openings 22 and the second supply openings 32 are connected to individual flow passages and are made common outside the printing head is the configuration shown in FIG. 3C. Any of the configuration shown in FIG. 3B and the configuration shown in FIG. 3C may be employed.

In the circulation flow passage for the ink in the inside and outside of the printing head, filters 31 for removing foreign matters in the ink may be included. In FIG. 3A to FIG. 3D, filters are disposed on the inlet side and outlet side, which are outside the individual flow passages. In addition, filters may be disposed between first energy generation elements and second energy generation elements in the individual flow passages. In this case, filters do not have to be disposed on the upstream side (the second energy generation element side), which is outside the individual flow passages.

### Drive Method (Toggle Drive)

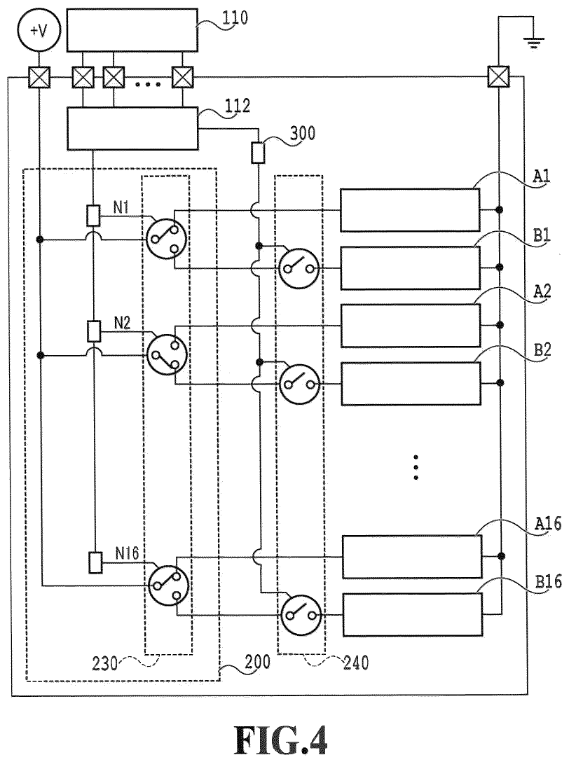

In the present embodiment, a selection drive circuit 200 shown in FIG. 4 is formed on the substrate 18. A voltage source and a controller 110 are included on the outside of the substrate, and these are connected to the selection drive circuit 200 on the substrate. The selection drive circuit 200 includes an on-on drive circuit (first switch which switches on-on) 230. The on-on drive circuit 230 turns on and drives any of the first energy generation elements (A1 to A16) and the second energy generation elements (B1 to B16) in response to a control signal in each address (N1 to N16 in the present example) received from a control data supply circuit 112. In this way, the selection drive circuit 200 includes a switch which is configured to be capable of exclusively switching the first energy generation elements and the second energy generation elements such that only one of these is brought into a drive possible state. This switch causes the state where the second energy generation elements are invariably not allowed to drive in the state where the first energy generation elements are allowed to drive. In contrast, in the state where the second energy generation elements are allowed to drive, the first energy generation elements are invariably not allowed to drive. Here, the control data supply circuit 112 controls drive pulses for driving the first energy generation elements or the second energy generation elements and time (interval) at which the drive pulse is applied to each element.

In the case where the second energy generation element side is selected by the on-on drive circuit 230, the drive is further controlled by an on-off drive circuit (a second switch which switches on-oft) 240 for the second energy generation elements in accordance with a drive possibility signal 300 for the second energy generation elements. That is, the second energy generation elements are further controlled by a switch which is configured to be capable of switching a drive possible state and a drive impossible state. Hence, in the case where the first energy generation elements are in the drive impossible state, the second energy generation elements are in the drive possible state, but are driven only in the case where the received drive possibility signal (indicating whether or not driving is enabled) for the second energy generation elements indicates that driving is possible. In the case where there is no drive possibility signal, even if the second energy generation element side is selected in the on-on drive circuit 230, the second energy generation elements are not driven. That is, in this case, none of the first energy generation elements and the second energy generation elements are driven.

To sum up the above, in the present embodiment, the drive circuit for controlling the drives of the first energy generation elements and the second energy generation elements is configured to bring only the first energy generation elements or the second energy generation elements into the drive possible state. Specifically, the drive circuit in the present embodiment includes the first switch configured to be capable of exclusively switching from each other as described above, and the second switch configured to be capable of switching the second energy generation elements between the drive possible state and the drive impossible state. By using the drive circuit having such a configuration, the drives of the first energy generation elements and the second energy generation elements are configured to be controlled under the following conditions.

The conditions on the above-described drive control are as follows. In the case of driving a certain first energy generation element, the second energy generation element corresponding to the certain first energy generation element is not driven. On the other hand, in the case where a certain first energy generation element is not driven and a drive signal of bringing the second energy generation element into a drive possible state is received, the second energy generation element corresponding to the certain first energy generation element is driven.

Moreover, it is preferable that the on-off drive circuit (second switch) be provided on the side closer to the second energy generation element than the on-on drive circuit (first switch), that is, on an electrically downstream-side relative to the second energy generation element. In addition, it is preferable to control the drives of a plurality of second energy generation elements by using a common drive signal described above.

Here, as a comparison, a measure against a thickened ink in a liquid ejection head which does not form a circulation flow will be described below. As the measure, there are a preliminary ejection operation of ejecting the ink from the ejection ports and a sucking operation of sucking the ink from the ejection ports. For example, in a serial-type liquid ejection apparatus, before the head is moved away from a cap which protects the head at a head standby position to conduct the printing operation, the preliminary ejection operation or the sucking operation is conducted. Alternatively, the preliminary ejection operation is conducted in a non-printing region which is displaced from the print medium in the case of reciprocating the printing operation with the carriage. These operations are conducted at a timing different from the printing operation. Moreover, in the case where the ink tends to be thickened, there is a case where the preliminary ejection operation is conducted on a printing medium in a printing region in the case of reciprocation, to such an extent that does not influence the image quality, in addition to the printing operation.

In the present embodiment, the number of times of the preliminary ejection operation or the sucking operation can be reduced by conducting the circulation operation by means of the drive of the second energy generation element. Regarding this, the circulation operation at the head standby position and in the non-printing region at the time of reciprocation is conducted at a timing different from the printing operation as in the case of the above-described liquid ejection head which does not form the circulation flow. For this reason, in the present embodiment, the drive of the second energy generation element can be easily controlled by the drive possibility signal 300 for the second energy generation element. Moreover, in the case of an ink which tends to be thickened, it is necessary to prioritize the ejection operation at a timing close to the printing operation in the circulation operation in a printing region at the time of reciprocation. On the other hand, it is unnecessary to simultaneously drive the circulation operation and the printing operation by providing a plurality of timings of the circulation operation or providing a certain period of time thereof. For this reason, in the present embodiment, the circulation operation can be controlled as appropriate without influence on the printing operation by driving the first energy generation element in the case where the first energy generation element side is selected.

In the present embodiment, the drive of the second energy generation element is controlled based on ejection data indicating ejection or non-ejection (that is, whether or not to drive the first energy generation element) for each ejection port and the drive possibility signal indicating whether or not to bring (all of) the second energy generation element into the drive possible state.

In addition, in the case where there are a plurality of second energy generation elements as well, it is possible to control the drive of the second energy generation elements based on a common drive possibility signal. In this way, since there is no need to provide drive data for individual second energy generation elements, there is an advantage that the drive data amount can be reduced for that. Note that although in the present embodiment, the first energy generation elements Ai and the second energy generation elements Bi are controlled by setting 32 elements (16 sets) in total, where i=up to 16, as one group, the number of elements in total to be one group may be various number such as 16 (8 sets), 24 (12 sets), or the like.

In addition, although an thermoelectric conversion element or a piezoelectric element can be employed as the second energy generation elements, the direction of the circulation flow in the case where a thermoelectric conversion element is employed is described in the present embodiment. Note that in the case of employing a piezoelectric element, there is a case where the direction of the circulation flow is opposite from the above-mentioned present embodiment depending on the drive method.

Although in the present embodiment, the case of controlling the drive of the second energy generation elements by providing the drive possibility signal 300 to the substrate 18 is shown, the drive of the second energy generation elements may be controlled by providing the drive possibility signal 300 to a liquid ejection head outside a substrate or to a liquid ejection apparatus outside a liquid ejection head.

### Circuit Configuration of Printing Element Board

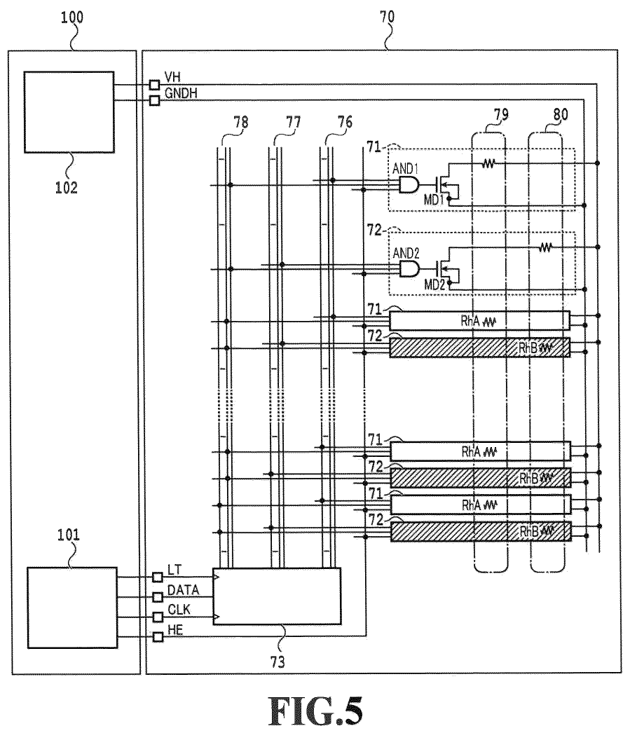

FIG. 5 shows a circuit configuration of the printing element board in the present embodiment. As shown in FIG. 5, the printing element board includes ejection modules 71 and circulation modules 72. The ejection module 71 includes an ejection heater (thermoelectric conversion element) RhA, an ejection drive element (transistor) MD1 for causing a current to flow through the heater RhA, and an ejection logic circuit AND1 for selectively driving the drive element MD1. A current is caused to flow through the ejection heater RhA to generate heat, so that bubbles are generated in the ink, and the ink is ejected to print a printing sheet surface.

The circulation module 72 includes a circulation heater (thermoelectric conversion element) RhB, a circulation drive element (transistor) MD2 for causing a current to flow through the heater RhB, and a circulation logic circuit AND2 for selectively driving the drive element MD2. A current is caused to flow through the circulation heater RhB to generate heat, so that bubbles of the ink grow, and a circulation flow is thus generated in an ink supply flow passage. Note that for the ejection heater RhA, a piezoelectric element can also be employed as an energy element for ejecting the ink, and for the circulation heater RhB, a piezoelectric element can also be employed as an energy element for circulating the ink.

To the ejection module 71, an ejection group selection signal 76 and a time-division selection signal 78 outputted from a control data supply circuit 73 as well as an enable signal HE for controlling a pulse width (time during which the drive element MD1 is turned on to cause the current to flow) are inputted. Specifically, these signals are inputted into the ejection logic circuit AND1 of the ejection module 71, and the ejection drive element MD1 is brought into a conduction state in accordance with each input signal, and the ejection module 71 is selectively controlled such that the current flows through the ejection heater RhA.

To the circulation module 72, a circulation group selection signal 77 and a time-division selection signal 78 outputted from a control data supply circuit 73 as well as an enable signal HE are inputted. Specifically, these signals are inputted into the circulation logic circuit AND2 of the circulation module 72, and the circulation module 72 is selectively controlled such that the current flows through the corresponding circulation heater RhB.

Regarding the supply of the time-division selection signal 78, the same signal line is shared between the ejection modules 71 and the circulation modules 72. This can contribute to a reduction in serial data transfer amount, which will be described later, and a reduction in a layout area of the signal wiring in the printing element board.

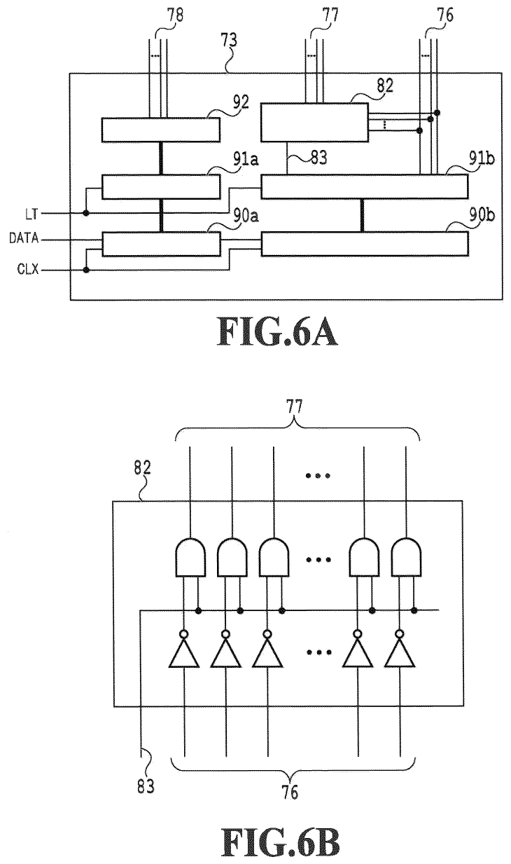

The control data supply circuit 73 is configured with shift registers 90a, 90b and latch circuits 91a, 91b as shown in FIG. 6A, for example. The control data supply circuit 73 includes three external input terminals. Specifically, these are external input terminals for a clock signal CLK for conducting serial data transfer of the selection information of the ejection modules 71 and the circulation modules 72 to the shift registers 90a, 90b, a data signal DATA, and a latch signal LT for holding the selection information. The clock signal CLK, the data signal DATA, and the latch signal LT are transmitted from a controller 101 mounted in the inkjet printing apparatus 100. In addition, the printing element board 70 also includes, as an external input terminal, an input terminal for the enable signal HE for controlling the pulse widths (times during which the transistor is turned on to cause the current to flow) of the drive elements MD1 or MD2 of the selected ejection modules 71 or the circulation modules 72. The enable signal HE is transmitted from the controller 101 mounted in the inkjet printing apparatus 100. The enable signal HE is a signal for adjusting the current pulse width so as to be capable of generating a desired thermal energy in consideration of manufacturing variations of heater resistance values in the printing element board 70, manufacturing variations of the power supply and the like, and a voltage drop in a power supply wiring in the case of simultaneously driving a plurality of heaters. It is preferable to prepare enable signals HE individually for ejection and for circulation, to control the pulse width on each. Note that since in the present embodiment, one enable signal HE is shared for ejection and for circulation for reducing the number of signal terminals, the pulse width cannot be controlled individually for ejection and for circulation. In view of this, it is preferable that the ejection heater RhA and the circulation heater RhB be formed in the same step of a semiconductor manufacturing process. In the case where the ejection heater RhA and the circulation heater RhB are formed in the same step, it is possible to adjust the pulse width with one enable signal HE by deeming that the two types of heaters thus formed have the same manufacturing variation (an amount of deviation in resistance value from an ideal value).

Here, deeming that one group includes n ejection heaters RhA, a drive control method for the ejection heater array 79 including m groups will be described. As an example, on the assumption of a printing element board in which heater arrays are arranged side by side at an arrangement density of 600 dpi in a length of 1 inch, the control method for (n=16)×(m=40 groups) ejection heaters RhA will be described below. These ejection heaters RhA are included in the respective ejection modules 71 as mentioned above. The 16 ejection modules 71 in each group are driven by the time-division selection signal 78 in a time-division drive. The time-division drive is a control system in which time of a certain ejection cycle is divided into 16 units, and the ejection modules 71 are sequentially driven one by one for the divided time units, respectively. In the same group, a plurality of ejection modules 71 are not simultaneously driven. In the time-division drive, since the ejection modules 71 are not simultaneously selected in a group, a decoder circuit 92 is mounted in the control data supply circuit 73 as shown in FIG. 6A, for example, in order to further reduce the serial transfer data amount from the inkjet printing apparatus 100. In this case, in the case of the time-division n=16, a decoder circuit 92 which converts 4-bit data to 16-bit data is used. Note that as the data amount of serial transfer increases, serial data transfer at a higher speed is required, leading to cost up and size up of signal transmission and reception circuits and transfer passages in the inkjet printing apparatus 100 or the printing element board 70. Hence, it is preferable to reduce the data amount.

The m-bit ejection group selection signal 76 for selectively driving any of them groups is outputted from the control data supply circuit 73. The group selection is a control which enables simultaneous selection, and signals of m bits which is the same as the number of groups are serially transferred from the inkjet printing apparatus 100. As mentioned above, the ejection module 71 is selectively controlled such that the current flows through the ejection heater RhA at the corresponding position as these ejection group selection signal 76, time-division selection signal 78, and enable signal HE are inputted into the ejection logic circuit AND1. Note that although in the present embodiment, the case where n=16 and m=40 is described, the same control can be conducted in the case where n=8 and m=80, the case where n=32 and m=40, and the like as other values, for example.

Next, the drive control method for the circulation heater array 80 will be described. Since the circulation heater RhB is an energy generation element which generates an ink circulation flow in an individual flow passage adjacent to the ejection port, it is necessary to dispose the circulation heater RhB near the ejection heater RhA, which is disposed directly below the ejection port, in a pair. In the present embodiment, a method for selectively controlling the circulation heater array 80 configured with (n=16)×(m=40 groups) circulation heaters RhB as in the case of the ejection heaters RhA from the inkjet printing apparatus 100 side will be described. Note that the circulation heaters RhB are included in the respective circulation modules 72 as mentioned above. The inside of each group is driven in a 16 time-division manner by the time-division selection signal 78 which is shared with the ejection modules 71. For group selection, a control which enables simultaneous drive by a 40-bit circulation group selection signal 77 is conducted. The circulation group selection signal 77 may be configured to be transferred together with ejection serial data from the inkjet printing apparatus 100; however, the present embodiment has a configuration in which the signal is generated by a circulation group selection circuit 82 in order to further reduce the data transfer amount. The circulation group selection circuit 82 is in the control data supply circuit 73, and is configured to generate the circulation group selection signal 77 in accordance with selection information contained in the ejection group selection signal 76. Specifically, a signal obtained by logically inverting each piece of selection information to each bit of the ejection group selection signal 76 is outputted as the circulation group selection signal 77. According to this circuit configuration, in the case where the ejection module 71 is in a selection state, the circulation module 72 arranged in a pair is in a non-selection state, while in the case where the ejection module 71 is in a non-selection state, the circulation module 72 arranged in a pair is in a selection state. That is, a pair of the ejection module 71 and the circulation module 72 are in a relationship of being selected exclusively from each other. Note that in the case where the time-division selection is not conducted in the time-division selection signal 78, both of the ejection module 71 and the circulation module 72 are not selected. In addition, in the present embodiment, a pump flag signal 83 for determining whether or not the circulation group selection signal 77 is made valid is further provided. By making the circulation group selection signal 77 invalid by the pump flag signal 83, the selection of the circulation module 72 is inhibited at the time of a normal printing operation which does not require ink circulation. The system for transferring the pump flag signal is desirably a system in which the pump flag signal is serially transferred from the inkjet printing apparatus.

The present embodiment employs a configuration in which the common power supply voltage VH (for example, 24 V) is connected as the power supply voltage and the common GNDH is connected as the ground potential, for the ejection modules 71 and the circulation modules 72. However, in the case where it is desirable to further reduce fluctuations in ejection energy due to a voltage drop in the case of simultaneously driving a plurality of heaters, it is unnecessary to also employ this configuration. In such a case, it is also possible to employ a configuration in which supply wirings and external connection terminals for the power supply voltage and ground potential are provided individually to the ejection modules 71 and the circulation modules 72 in a printing element board, and the power supply voltage and ground potential are supplied individually from the power supply circuit 102 mounted in the inkjet printing apparatus 100 to the ejection modules 71 and the circulation modules 72.

In general, since a drive element is operated at a higher voltage than that of a logic circuit, a board including both a high-voltage-tolerant transistor and a normal transistor together is used. In the present embodiment as well, the ejection drive elements MD1 and the circulation drive elements MD2 are configured with DMOS transistors (Double-diffused MOSFETs), which are high-voltage-tolerant MOS transistors. Logic circuits such as the ejection logic circuit AND1 and the circulation logic circuit AND2, the circulation group selection circuits 82 as well as the other shift registers 90a and 90b, the latch circuits 91a and 91b, and the decoder circuit 92 are configured with low-voltage-tolerant MOS transistors.

A thermal energy for circulating the ink in the individual flow passages is generated by the drive current of the circulation heaters RhB. In the case where the drive current of the circulation heaters RhB is smaller than the drive current of the ejection heaters RhA for ejecting the ink onto the printing sheet surface, since the current drive capability of the DMOS transistors may be small, a configuration in which the area of the circulation drive element MD2 is smaller than the area of the ejection drive element MD1 is preferable.

### Control Configuration of Printing Apparatus

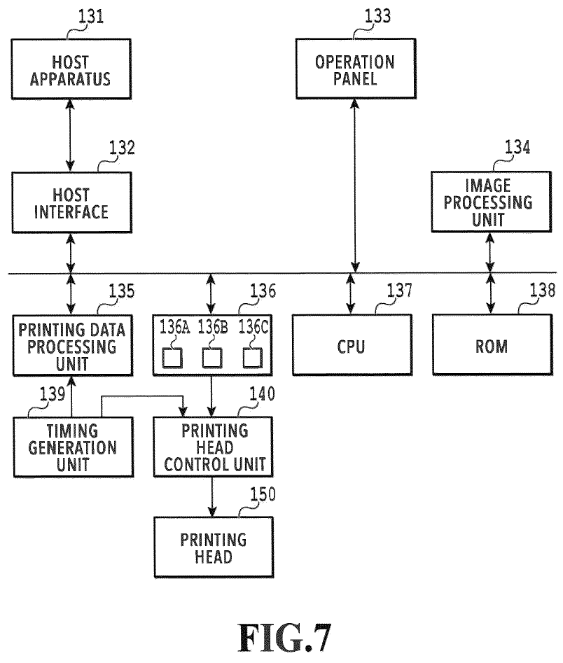

FIG. 7 is a block diagram showing a control configuration of the printing apparatus in the present embodiment.

Into a host interface 132, image data is inputted from a host apparatus 131. This image data is stored in a reception buffer 136A provided in a RAM 136. An image processing unit 134 converts the image data to multi-valued data of color components of CMYK, and stores the multi-valued data into a multi-valued data buffer 136B provided in the RAM 136. A printing data processing unit 135 converts the multi valued data to dot data (binary data), and stores the dot data (binary data) into a dot data buffer 136C. A printing head control unit 140 transfers the binary data stored in the dot data buffer 136C to the printing head. The processing in the printing data processing unit 135 is synchronized with a heat trigger signal outputted by a timing generation unit 139, and the printing head control unit 140 is synchronized with a block trigger signal outputted by the timing generation unit 139 to achieve processing in conformity with a conveyance timing.

The user sends instructions to the printing apparatus via an operation panel 133. A CPU 137 conducts a drive control of the printing elements, a relative conveyance control between the printing elements and the printing medium (for example, a sheet), and the like in accordance with control programs stored in a ROM 138.

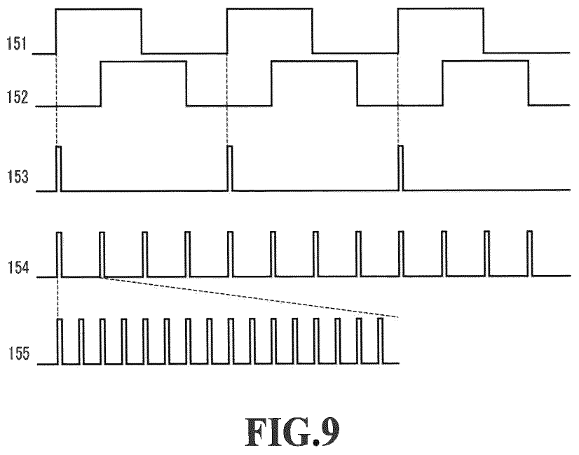

Hereinafter, the generation of a data transfer timing used in general will be described by using FIG. 9. Here, a case in which printing data for one column is divided into 16 timings and driven (time-division drive) will be described as an example.

An encoder signal (A phase) 151 and an encoder signal (B phase) 152 which is shifted by a quarter cycle in phase are inputted from an encoder into the timing generation unit 139. In the timing generation unit 139, a reference pulse 153 is generated at a timing of a rising edge of the encoder signal 151, and the heat trigger signal 154 which is outputted at intervals corresponding to a printing resolution is generated by multiplying a frequency of the reference pulse 153. Moreover, the block trigger signal 155 is generated by dividing the interval of the heat trigger signal 154 by 16. Data is inputted into the printing head at the timings of this block trigger signal 155. Printing can be made at a desired position by conducting data transfer in a period of the cycle of the block trigger signal 155 generated based on the encoder signal, which is position information of the carriage in this way.

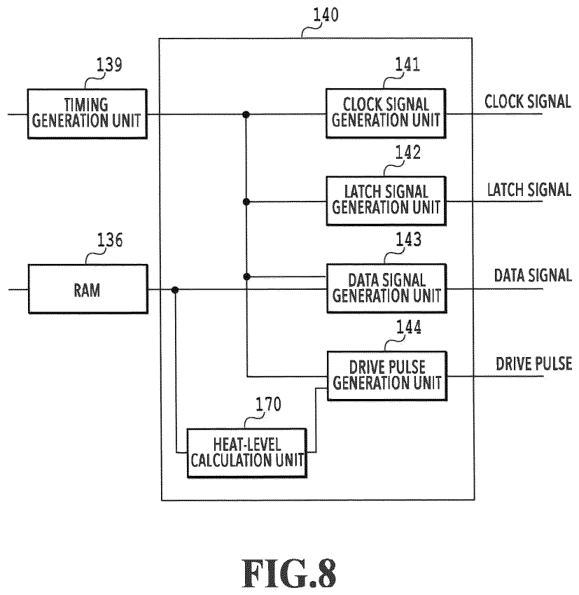

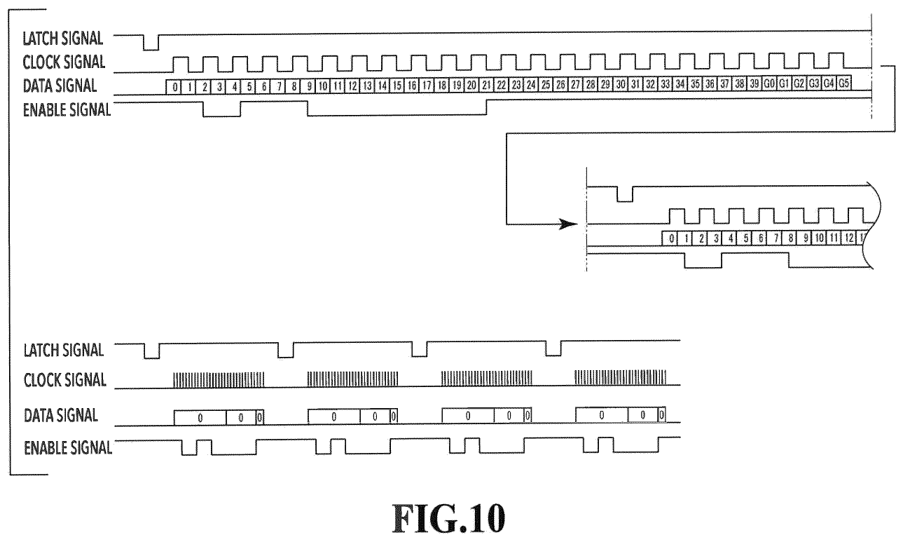

Hereinafter, the printing head control unit 140 will be described by using FIG. 8 and FIG. 10.

FIG. 8 is a block diagram showing a configuration of the printing head control unit 140. The printing head control unit 140 is operated based on the timing of the block trigger signal 155 generated by the timing generation unit 139.

Upon input of the block trigger signal 155, a clock signal generation unit 141 generates a clock signal having a predetermined number of cycles, and transmits the generated clock signal to the printing head. In the example of FIG. 10, a clock signal for 23 cycles is generated; however, the number of cycles of the clock signal to be generated can be changed by setting, and the necessary number of cycles is determined m accordance with the number of bits of data to be transmitted to the printing head.

Upon input of the block trigger signal 155, a latch signal generation unit 142 generates a latch signal, and transmits the generated latch signal to the printing head.

Upon input of the block trigger signal 155, a data signal generation unit 143 reads data from the RAM 136, and temporarily stores data for one time-division drive in an inside buffer, and transfers the data to the printing head at a timing at which the next block trigger signal 155 is inputted. Although FIG. 10 shows transfer data in which the ejection group selection signal has 40 bits (0 to 39) and the time-division selection signal has 6 bits (G0 to G5), it is possible in the 16 time-division drive to transfer 0 to 15 time division selection data with 4 bits of G0 to G3, G4 and G5 are unnecessary. In view of this, it is possible to control the switching between validity and invalidity of the circulation modules 72 by assigning the pump flag signal 83 to G4 or G5, and transferring the pump flag signal 83 to the printing head.

A drive pulse generation unit 144 generates a drive pulse determined in the heat-level calculation unit 170 based on data which the data signal generation unit 143 read from the RAM 136, and transmits the generated drive pulse to the printing head.

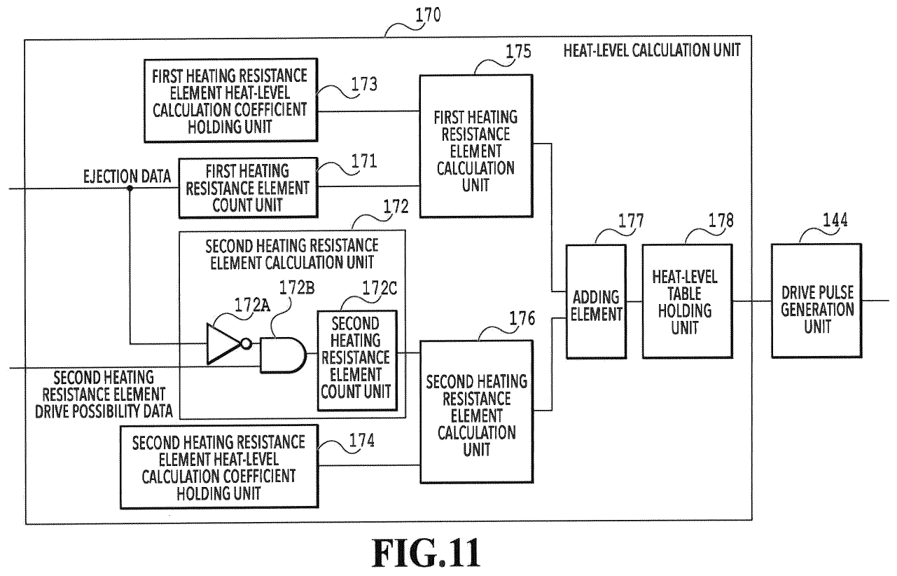

FIG. 11 is a detailed block diagram of a heat-level calculation unit 170 (see FIG. 8) and is a diagram for explaining the generation of drive pulses for the first heating resistance element and the second heating resistance element. Note that in the present Specification, the “first heating resistance element” is another name of the aforementioned first energy generation element 14, and the “second heating resistance element”is another name of the aforementioned second energy generation element 24.

The data read from the RAM 136 is divided into ejection data indicating whether or not to eject the ink for each ejection port, and second heating resistance element drive possibility data indicating whether or not to bring (all of) the second heating resistance elements into a drive possible state, and inputted into the heat-level calculation unit 170. The ejection data is inputted into a first heating resistance element count unit 171 and a second heating resistance element calculation unit 172, and the second heating resistance element drive possibility data is inputted into the second heating resistance element calculation unit 172. Regarding ink droplets of a plurality of sizes (in other words, nozzles of a plurality of sizes), the first heating resistance element count unit 171 counts the number of the first heating resistance elements to be simultaneously driven, for the first heating resistance elements associated with each size. Specifically, for example, the count is made such that the number of the first heating resistance elements having nozzles of a large size is counted as 30, the number of the first heating resistance elements having nozzles of a middle size is counted as 20, and the number of the first heating resistance elements having nozzles of a small size is counted as 10, or the like.

In the second heating resistance element calculation unit 172, the inputted ejection data is inverted by an inverting element 172A, and logical AND with the second heating resistance element drive possibility data is obtained by an AND element 172B. The number of the second heating resistance elements to be simultaneously driven is counted by a second heating resistance element count unit 172C by using output data thus generated of the AND element 172B. That is, at a timing at which the second heating resistance element drive possibility data is inputted, in the case where the inputted second heating resistance element drive possibility data indicates that driving is possible, the number of the first heating resistance elements which are not driven is the number of the second heating resistance elements.

In a first heating resistance element heat-level calculation coefficient holding unit 173, a first heating resistance element count unit 171 conducts count, and the first heating resistance element heat-level calculation coefficient holding unit 173 holds calculation coefficients required for calculation for determining drive pulses of the respective first heating resistance elements associated with sizes, based on the result of the count. Regarding the holding of the calculation coefficient, the drive pulse to be supplied to one ejection heater also becomes different depending on the magnitude of the size of the ink droplets to be ejected (in other words, the size of the nozzles). For this reason, it is necessary to hold calculation coefficients for different sizes. Similarly, in a second heating resistance element heat-level calculation coefficient holding unit 174, a second heating resistance element count unit 172C conducts count, and the second heating resistance element heat-level calculation coefficient holding unit 174 holds calculation coefficients required for calculation for determining drive pulses of the second heating resistance elements to be simultaneously driven, based on the result of the count. Note that the calculation coefficients held in each of the first heating resistance element heat level calculation coefficient holding unit 173 and the second heating resistance element heat-level calculation coefficient holding unit 174 may be configured to be capable of being set by the user in advance, or may be configured to be capable of being changed thereafter.

The first heating resistance element calculation unit 175 conducts calculation for determining the drive pulses of the first heating resistance elements based on the number of counts of the first heating resistance elements having different sizes of ink droplets to be ejected, and the first heating resistance element heat-level calculation coefficients for different sizes. Similarly, in the case where the second heating resistance element drive possibility data is inputted, the second heating resistance element calculation unit 176 conducts calculation for determining the drive pulses of the second heating resistance elements based on the number of counts of the second heating resistance elements to be simultaneously driven, and the second heating resistance element heat-level calculation coefficient.

Then, in an adding element 177, the calculation result of the first heating resistance element calculation unit 175 and the calculation result of the second heating resistance element calculation unit 176 are added. This result of addition is matched to a heat-level table held in a heat-level table holding unit 178 to determine heat levels indicating drive pulses to be generated.

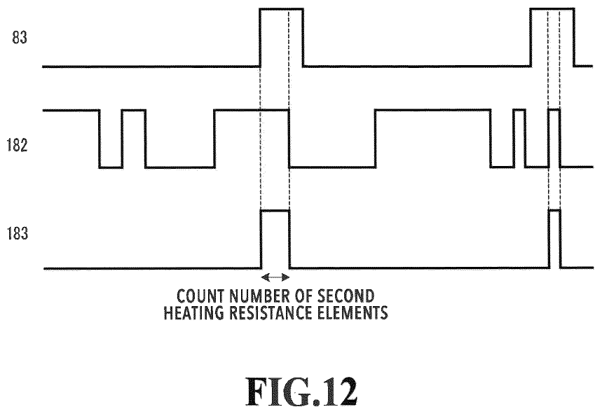

FIG. 12 is a diagram showing the count of the number of the second heating resistance element. In the case where an inverted signal 182 of the ejection data is valid (at the time of so-called assertion), the first heating resistance elements are in a non-driven state. In the case where the inverted signal 182 is invalid (at the time of so-called negation), the first heating resistance elements are in a driven state. In the case where both of the second heating resistance element drive possibility data and the inverted signal 182 of the ejection data are asserted, second heating resistance element drive data 183 is generated, and accordingly, the number of the second heating resistance elements driven at this time is counted.

Hereinafter, a case where the number of the ejection modules 71 and the number of the circulation modules 72 in the printing element board are each 100, and the size of the ink droplets to be ejected (in other words, the size of the nozzles) is one type will be described as an example. In addition, a heat-level calculation coefficient for one ejection heater RhA in this case is represented by 2K, and a heat-level calculation coefficient for one circulation heater RhB in this case is represented by K.

It is assumed that the number of the ejection modules 71 driven at a certain timing is 70. In the case where the second heating resistance element drive possibility data is not inputted, the calculation result (K value) by the first heating resistance element calculation unit 175 is 2K*70=140K.

In contrast, in the case where the inputted second heating resistance element drive possibility data indicates that driving is possible, the calculation result (K value) by the first heating resistance element calculation unit 175 is 2K*70=140K, and the calculation result (K value) by the second heating resistance element calculation unit 176 is K*(100−70)=30K. The calculation result calculated by the first heating resistance element calculation unit 175 and the calculation result calculated by the second heating resistance element calculation unit 176 are added in the adding element 177. That is, in the above-described example, the calculation result in the case where the second heating resistance element drive possibility data is inputted is 140K+30K=170K. This calculation result thus calculated is matched to the heat-level table held in the heat-level table holding unit 178 to derive a value of the heat level corresponding to the calculation result 170K (specifically, for example, heat level 4). In this way, the drive pulse necessary for simultaneous drive of the first heating resistance elements and the second heating resistance elements can be determined. Hence, an appropriate drive pulse can be generated by the subsequent drive pulse generation unit 144, the generated drive pulse can be supplied to the printing head, and ejection failures of the ink can be prevented. Note that in the heat-level table held in the heat-level table holding unit 178, a correspondence relation between K values which can be obtained as calculation results and values of heat levels are written.

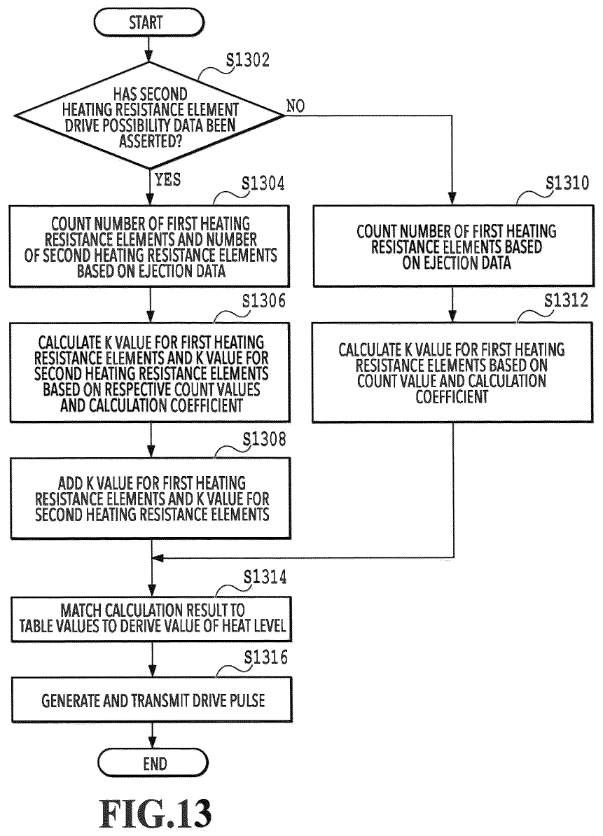

Here, the case where the size of the ink droplets to be ejected in the ejection modules 71 is one type has been described, the printing head may be a printing head which ejects ink droplets of a plurality of sizes. In this case, the number of the first heating resistance elements to be driven is counted in accordance with each size. Then, based on the result of the count, the same effect can be obtained by conducting calculation for determining drive pulses using a calculation coefficient for each size of the ink droplets to be ejected from the first heating resistance elements to be simultaneously driven. Hereinafter, a series of such flow will be described by using FIG. 13.

In S1302, the heat-level calculation unit 170 determines whether or not second heating resistance element drive possibility data has been asserted. If the result of determination in the present step is true, the processing proceeds to S1304. On the other hand, if the result of determination is false, the processing proceeds to S1310.

In S1304, the number of the first heating resistance elements and the number of the second heating resistance elements for each size of the ink droplets to be ejected are counted. Specifically, the first heating resistance element count unit 171 counts the number of the first heating resistance elements for each size of the ink droplets to be ejected, based on ejection data. In addition, the second heating resistance element count unit 172C counts the number of the second heating resistance elements based on the ejection data and second heating resistance element drive possibility data.

In S1306, a K value for the first heating resistance elements and a K value for the second heating resistance elements are calculated. Specific calculation processing is as follows. The first heating resistance element calculation unit 175 calculates the K value for the first heating resistance elements based on a count value of the number of the first heating resistance elements for each size, which is obtained in S1304, and a calculation coefficient for the each size, which is held in the first heating resistance element heat-level calculation coefficient holding unit 173. In addition, the second heating resistance element calculation unit 176 calculates the K value for the second heating resistance elements based on a count value of the number of the second heating resistance elements, which is obtained in S1304, and a calculation coefficient, which is held in the second heating resistance element heat-level calculation coefficient holding unit 174.

In S1308, the adding element 177 adds the calculation result (the K value for the first heating resistance elements) of the first heating resistance element calculation unit 175, which is obtained in S1306, and the calculation result (the K value for the second heating resistance elements) of the second heating resistance element calculation unit 176, which is obtained in S1306.

In S1310, the first heating resistance element count unit 171 counts the number of the first heating resistance elements for each size of the ink droplets to be ejected, based on ejection data.

In S1312, the first heating resistance element calculation unit 175 calculates a K value for the first heating resistance elements based on a count value for each size, which is obtained in S1310, and a calculation coefficient for the each size, which is held in the first heating resistance element heat-level calculation coefficient holding unit 173.

In S1314, the heat-level calculation unit 170 matches the calculation result (K value), which is calculated in S1308 or S1312, to values of heat levels written as table values of the heat-level table, which is held in the heat-level table holding unit 178. Then, the heat-level calculation unit 170 derives a value of a heat level corresponding to the K value.

In S1316, the drive pulse generation unit 144 generates a drive pulse corresponding to the value of the heat level, which is derived in S1314, and transmits the generated drive pulse to the printing head.

The above-described processing makes it possible to apply an appropriate drive pulse considering the drive of the second heating resistance elements even in a printing head which ejects ink droplets of a plurality of sizes.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can provide a technology for applying an appropriate drive pulse.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167258, filed Sep. 26, 2024, which is hereby incorporated by reference herein in its entirety.

What is claimed is:

1. A printing apparatus comprising:
a printing head which includes a plurality of first heating resistance elements which generate an energy for ejecting a liquid from a plurality of ejection ports, and a plurality of second heating resistance elements which generate an energy for generating a flow of the liquid in a flow passage; and
a control unit which controls the printing head based on ejection data indicating ejection or non-ejection for each of the plurality of ejection ports, and drive data indicating whether or not driving is enabled for the plurality of second heating resistance elements, the control unit including a heat-level calculation unit which derives a heat level based on the ejection data and the drive data, and a drive pulse generation unit which generates a drive pulse in accordance with the derived heat level, in which in a case where the ejection data for each of the plurality of ejection ports indicates non-ejection and the drive data indicates that driving is enabled, the control unit drives the second heating resistance element corresponding to the each ejection port, wherein
the heat-level calculation unit includes a calculation unit which calculates the number of the second heating resistance elements to be simultaneously driven, based on the ejection data and the drive data.

2. The printing apparatus according to claim 1, wherein the heat-level calculation unit further includes a first count unit which counts the number of the first heating resistance elements to be simultaneously driven, based on the ejection data.

3. The printing apparatus according to claim 2, wherein
the calculation unit includes: an inverting element which inverts the ejection data; an AND element which takes a logical AND of the ejection data inverted by the inverting element and the drive data; and a second count unit which counts the number of the second heating resistance elements to be simultaneously driven, by using an output data of the AND element.

4. The printing apparatus according to claim 3, wherein
the heat-level calculation unit further includes a first coefficient holding unit which holds a first coefficient for the first heating resistance elements, and
the first coefficient is a coefficient for each size of liquid droplets to be ejected.

5. The printing apparatus according to claim 4, wherein the heat-level calculation unit further includes a first calculation unit which calculates a K value for the first heating resistance elements based on a first number of counts for the first heating resistance elements for each size of the liquid droplets to be ejected, which is obtained by the first count unit, and the first coefficient, which is held in the first coefficient holding unit.

6. The printing apparatus according to claim 5, wherein the heat-level calculation unit further includes a second coefficient holding unit which holds a second coefficient for the second heating resistance elements.

7. The printing apparatus according to claim 6, wherein the first coefficient, which is held in the first coefficient holding unit, and the second coefficient, which is held in the second coefficient holding unit, can be set by a user.

8. The printing apparatus according to claim 7, wherein the heat-level calculation unit further includes a second calculation unit which calculates a K value for the second heating resistance elements based on a second number of counts for the second heating resistance elements, which is obtained by the calculation unit, and the second coefficient, which is held in the second coefficient holding unit.

9. The printing apparatus according to claim 8, wherein the heat-level calculation unit further includes an adding element which adds the K value for the first heating resistance elements, which is calculated by the first calculation unit, and the K value for the second heating resistance elements, which is calculated by the second calculation unit.

10. The printing apparatus according to claim 9, further comprising a heat-level table holding unit which holds a heat-level table in which a correspondence relation between K values and values of heat levels is written.

11. The printing apparatus according to claim 10, wherein the heat-level calculation unit matches a K value as an output of the adding element to the values of the heat levels written in the heat-level table to derive a value of a heat level corresponding to the K value.

12. The printing apparatus according to claim 1, wherein
the plurality of first heating resistance elements are provided to correspond respectively to the plurality of ejection ports, and
the plurality of second heating resistance elements are provided to correspond respectively to the plurality of first heating resistance elements.

13. The printing apparatus according to claim 12, wherein the liquid is an ink.

14. A control method for a printing apparatus including:
a printing head which includes a plurality of first heating resistance elements which generate an energy for ejecting a liquid from a plurality of ejection ports, and a plurality of second heating resistance elements which generate an energy for generating a flow of the liquid in a flow passage; and
a control unit which controls the printing head based on ejection data indicating ejection or non-ejection for each of the plurality of ejection ports, and drive data indicating whether or not driving is enabled for the plurality of second heating resistance elements, the control unit including a heat-level calculation unit which derives a heat level based on the ejection data and the drive data, and a drive pulse generation unit which generates a drive pulse in accordance with the derived heat level, in which in a case where the ejection data for each of the plurality of ejection ports indicates non-ejection and the drive data indicates that driving is enabled, the control unit drives the second heating resistance element corresponding to the each ejection port,
the control method comprising:
calculating the number of the second heating resistance elements to be simultaneously driven, based on the ejection data and the drive data by means of the heat-level calculation unit.

15. A non-transitory computer readable storage medium storing a program which causes a computer to execute a control method for a printing apparatus including:
a printing head which includes a plurality of first heating resistance elements which generate an energy for ejecting a liquid from a plurality of ejection ports, and a plurality of second heating resistance elements which generate an energy for generating a flow of the liquid in a flow passage; and
a control Unit which controls the printing head based on ejection data indicating ejection or non-ejection for each of the plurality of ejection ports, and drive data indicating whether or not driving is enabled for the plurality of second heating resistance elements, the control unit including a heat-level calculation Unit which derives a heat level based on the ejection data and the drive data, and a drive pulse generation unit which generates a drive pulse in accordance with the derived heat level, in which in a case where the ejection data for each of the plurality of ejection ports indicates non-ejection and the drive data indicates that driving is enabled, the control Unit drives the second heating resistance element corresponding to the each ejection port,
the control method comprising:
calculating the number of the second heating resistance elements to be simultaneously driven, based on the ejection data and the drive data by means of the heat-level calculation unit.
